(19) United States
(12) Patent Application Publication
(10) Pub. No.: US 2025/0315270 A1
(43) Pub. Date: Oct. 9, 2025

(54) DYNAMIC SENSOR CONFIGURATIONS IN A HETEROGENEOUS COMPUTING PLATFORM

(71) Applicant: Dell Products L.P., Round Rock, TX (US)

(72) Inventors: Ibrahim Sayyed, Georgetown, TX (US); Adolfo S. Montero, Pflugerville, TX (US); Alan H. Abdelhalim, Pflugerville, TX (US)

(73) Assignee: Dell Products L.P., Round Rock, TX (US)

(21) Appl. No.: 18/625,284

(22) Filed: Apr. 3, 2024

(51) Int. Cl. G06F 9/445

(52) U.S. Cl. CPC G06F 9/44505

(57) ABSTRACT

Systems and methods include an Information Handling System (IHS) that is adapted to manage the operation of sensors that are coupled to the IHS. An Embedded Controller (EC) of the IHS receives a sensor configuration request and identifies one or more sensors of the IHS that are to be configured based on the request. The EC identifies an interface for accessing each of these sensors, where interface may be managed directly by the EC or may be managed by another hardware component of the IHS. The EC identifies one or more hardware registers for configuring each respective sensor. Via the identified interface, the EC modifies the identified hardware registers for each of the sensors in order to fulfill the sensor configuration request.

### FIELD

This disclosure relates generally to Information Handling Systems (IHSs), and more specifically, to systems and methods for managing operations of IHSs.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHS may include a wide variety of sensors. The sensors of an IHS may including environmental sensors for detecting ambient conditions in proximity to the IHS, such as ambient lighting and temperature in proximity to the IHS. These environmental sensors may also include sensors for measuring temperatures and other operating conditions at internal locations of an IHS. Battery sensors may provide state of charge and data characterizing other battery conditions. Time-of-flight sensors may be used to locate individuals and objects in proximity to the IHS. Accelerometers or other inertial measurement sensors may be used in detecting shocks experienced by an IHS. Gyroscope sensors may be used in detecting the physical orientation of the IHS for use in determining a physical posture of the IHS and/or whether the IHS is currently in transit. Cameras and network devices may also provide sensors inputs, such as in detecting an individual's presence in proximity to the IHS and to establish a location of the IHS. In a heterogeneous computing platform, these types of sensor inputs may be utilized by a wide variety of applications. Delays in configuring such sensors of the IHS may prevent these applications from operating effectively.

### SUMMARY

In various embodiments, Information Handling Systems (IHSs) may include: a plurality of sensors; an Embedded Controller (EC); and a memory coupled to, or integrated into, the EC, wherein the memory comprises program instructions that, upon execution by the EC, cause the EC to: receive a sensor configuration request; identify a first of the plurality of sensors of the IHS for configuration based on the request; identify an interface for accessing the first sensor; identify a plurality of hardware registers for configuring the first sensor; and via the identified interface, modify the plurality of hardware registers of the first sensor based on the sensor configuration request.

In some embodiments, the sensor comprises at least one of: an accelerometer, a gyroscope, or an Inertial Measurement Unit (IMU). In some embodiments, the sensor configuration request comprises a request to modify a sensitivity setting for use by an accelerometer in detecting shock events experienced by the IHS. In some embodiments, the sensor configuration request is received from an operating system application running on the IHS. In some embodiments, the interface for accessing the first sensor comprises a sideband management pathway between the first sensor and the EC. In some embodiments, the interface for accessing the first sensor comprises an interface operated by a sensor hub of the IHS. In some embodiments, the sensor hub is implemented by an SoC (System-on-Chip) of the IHS. In some embodiments, the SoC receives the modifications transmitted by the EC and relays the modifications to the first sensor without interfacing with the plurality of hardware registers of the first sensor. In some embodiments, the modifications are requested by a service OS operating on the SoC. In some embodiments, operations of the first sensor are updated according to the configuration request without reinitializing hardware or software of the IHS. In some embodiments, operations of the first sensor are updated according to the configuration request without modifications to firmware used to operate the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of components of an Information Handling System (IHS) that is configured, according to some embodiments, for dynamic configuration of sensors of the IHS.

FIG. 2 is a diagram illustrating an example of a heterogenous computing platform configuring, according to some embodiments, for dynamic configuration of sensors.

FIG. 3 is a diagram illustrating an example of a system, according to some embodiments, for dynamic configuration of sensors of an IHS.

FIG. 4 is a diagram illustrating certain components of an IHS configured, according to some embodiments, for dynamic configuration of sensors of the IHS.

FIG. 5 is a diagram illustrating an example of a method, according to some embodiment, for dynamic configuration of sensors of an IHS.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

The terms “heterogenous computing platform,” “heterogenous processor,” or “heterogenous platform,” as used herein, refer to an Integrated Circuit (IC) or chip (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device has different processing capabilities suitable for handling a specific type of computational task. Examples of heterogenous processors include, but are not limited to: QUALCOMM's SNAPDRAGON, SAMSUNG's EXYNOS, APPLE's “A” SERIES, etc., which typically include ARM core(s).

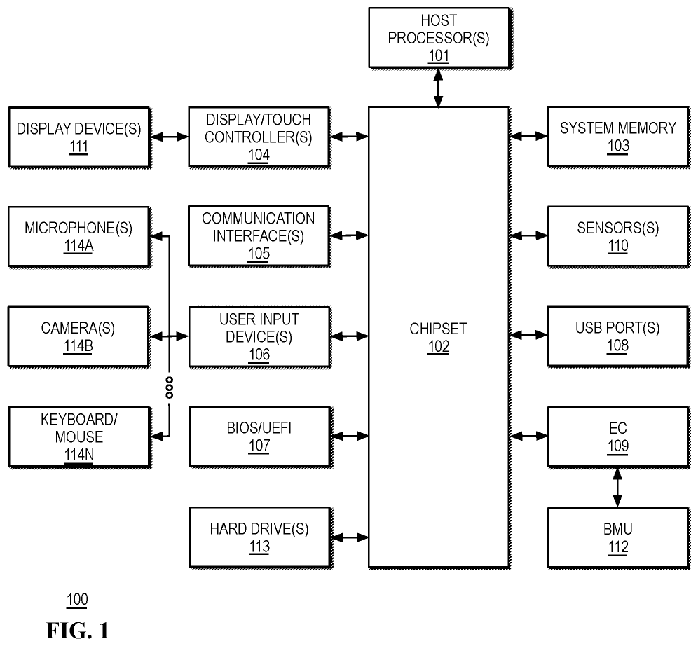

FIG. 1 is a block diagram of components of an IHS (Information Handling System) 100 that, in some embodiments, may include a heterogenous computing platform, as described in additional detail below, and that is configured for dynamic configuration of sensors of the IHS, in particular for configuration of sensor of the IHS without rebooting any hardware or software of the IHS, and without modifying any firmware used to operate the IHS. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless networks, such as ETHERNET, WIFI, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, headsets, etc.). Moreover, communication interface(s) 105 may be coupled to chipset 102 via a Peripheral Component Interconnect Express (PCIe) bus, or the like. Chipset 102 may be coupled to display and/or touchscreen controller(s) 104, which may include one or more or Graphics Processor Units (GPUs) on a graphics bus, such as an Accelerated Graphics Port (AGP) or PCIe bus. As shown, display controller(s) 104 provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be operate as a single continuous display, rather than two discrete displays.

Chipset 102 may provide host processor(s) 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more USB ports 108, to which one or more peripheral devices may be coupled (e.g., integrated or external webcams, microphones, speakers, etc.). Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.).

In certain embodiments, chipset 102 may further provide an interface for communications with one or more hardware sensors 110. Sensor(s) 110 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), accelerometer, etc.

Data collected by sensors 110 may be used in a variety of manners. Some collected sensor 110 data may be transmitted as part of one or more streams of telemetry that are being generated by the IHS 100. In some instances, sensors 110 may sub-components of other hardware components of an IHS, such as a thermal sensor 110 that is an integrated component of a GPU. In some instances, sensors 100 may be a standalone hardware component, such as an accelerometer device that is fixed to the motherboard and provides indications and measurements of detected movement of the IHS 100.

As described in additional detail below, in some embodiments, the data that is collected and/or transmitted by sensors 110 may be directly configured for updated operations through modifications to hardware settings that are supported by individual sensors. For instance, some sensors 110 may be configured though one or more hardware registers, where the status of an individual register may configure a specific setting of a sensor, such as a register used to set a gravitational threshold for use by an accelerometer. As described in additional detail below, in some embodiments, such sensor 110 configurations may be initiated within a heterogenous computing platform through an interface supported by an embedded controller 109 of the IHS, where the heterogenous computing platform may have limited knowledge of sensor configurations and are otherwise unable to dynamically update sensor operations.

Basic Input/Output System (BIOS) 107 is coupled to chipset 102. Unified Extensible Firmware Interface (UEFI) was designed as a successor to BIOS, and many modern IHSs utilize UEFI in addition to or instead of a BIOS. Accordingly, the term “BIOS” is also intended to also encompass a UEFI component. In operation, BIOS 107 provides an abstraction layer that allows the OS to interface with certain hardware components that are utilized by IHS 100.

Upon booting of IHS 100, host processor(s) 101 may utilize program instructions of BIOS 107 to initialize and test hardware components coupled to IHS 100, and to load host OS 300 for use by IHS 100. Via the hardware abstraction layer provided by BIOS 107, software stored in system memory 103 and executed by host processor(s) 101 can interface with certain I/O devices that are coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as operating chassis buttons and/or switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing a battery charger and a battery, enabling remote management, diagnostics, and remediation over an OOB or sideband network, etc. Moreover, in various implementations, EC 109 may be configured to perform operations for dynamic configuration of sensors 110 of an IHS 100, as described in more detail below.

Unlike other devices in IHS 100, EC 109 may be operational from IHS being powered, in particular before other devices are fully running or even powered. As such, EC 109 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.). From the perspective of users, IHS 100 may appear to be either “on” or “off,” without any other detectable power states. In some embodiments, however, an IHS 100 may support multiple power states that may correspond to the states defined in the Advanced Configuration and Power Interface (ACPI) specification, such as: S0, S1, S2, S3, S4, S5, and G3.

For example, when an IHS 100 is operating in S0 working mode, the IHS is operational, but some hardware components that are not in use may still be individually configured in low power states. In an S0 low-power, idle mode (“Sleep” or “Modern Standby”), an IHS 100 remains partially running with various capabilities of the IHS (e.g., displays, network controllers) may be powered down and other capabilities (e.g., EC, processors) may be in low-power standby modes, thus supporting the ability of the IHS to quickly transition from to a full-power, working S0 mode in response to various events. In the past, S3 was commonly used as a default “Sleep state.” However, many IHSs 100 utilize the described Modern Standby, which may bed designated as a hybrid “SOix” mode, where some or all of the internal hardware of IHS 100 may be placed into their lowest power state, while still supporting code execution that allows fast response and transition of the IHS to a working S0 mode.

An IHS 100 may additionally or alternatively support other low-power modes, such as S1-S3 (that may also be referred to as “Sleep” modes), where the IHS may appear to users to be in an off state. Some IHSs may support only one or two of these states, where the number of distinct states may be a reflection of power saving features of the IHS that have been selected for use. For instance, the amount of power consumed in states S1-S3 is less than S0 and more than S4. An S3 mode consumes less power than S2, and S2 consumes less power than S1. In states S1-S3, volatile memory may be periodically refreshed in order to maintain the operating state of the IHS, with some components remaining powered so that the IHS may wake based on inputs from a keyboard, Local Area Network (LAN), or a Universal Serial Bus (USB) device.

In the S4 state (“Hibernate”), power consumption is reduced to its lowest level. The IHS saves the contents of volatile memory to a hibernation file and some components remain powered, allowing the IHS to wake based on detected input from the keyboard, LAN, or a USB device. “Hybrid sleep” may implemented by some IHSs may use a hibernation file that is used to save the IHS's operating state, and also used to resume the IHSs operations upon reverting to a working S0 mode. “Fast startup” may refer to a power state where the user is logged off before the hibernation file is created, which allows for a smaller hibernation file in IHSs with reduced storage capabilities.

When in the S5 state (“Soft off” or “Full Shutdown”), an IHS 100 is fully shut down without a hibernation file. It occurs when a restart is requested or when an application invokes a shutdown command of the OS, EC 109, etc. During a full shutdown and re-boot, the user session is methodically de-constructed and restarted on the next boot. In some instances, a boot/startup from an S5 state takes significantly longer than resuming from S1-S4 states. At the hardware level, the main difference between S4 and S5 may be that S4 sets a flag on the storage device used to store the hibernation file and configures the bootloader to boot from the flagged hibernation file instead of booting the OS from scratch.

In a G3 (“Mechanical off”) power mode, the IHS 100 may be completely turned off and consumes absolutely no power from its Power Supply Unit (PSU) or main battery (e.g., a lithium-ion battery), with the exception of any Real-Time Clock (RTC) batter (ies) (e.g., Complementary Metal Oxide Semiconductor or “CMOS” batteries, Basic Input/Output System or “BIOS” batteries, coin cell batteries, etc.), which are used to provide power for the IHS's internal clock/calendar and for maintaining certain configuration settings. In some instances, G3 represents the lowest possible power configuration of an IHS from which the IHS can be initialized. From a G3 mode, an IHS may transition to an S5 mode in response to AC power source coupling (i.e., transitioning between battery mode to AC mode). Additionally, or alternatively, an IHS may transition from G3 to S0 based upon the detection of a power button event.

As described herein, various operations for configuration of sensors may be performed while an IHS remains in an S0 state, thus allowing sensor 110 configurations to be implemented without affecting other operations of the IHS, and for sensor 110 reconfigurations to be implemented dynamically in response to changes in context in the operation of the IHS. For example, the embedded controller 109 may be configured with an always-on power rail or the like, such that the EC continues to communicate with sensors and other IHS components while a host processor of the IHS is in an off, low-power, sleep, or standby state (e.g., S5, Modern Standby, etc.). As described in more detail below, in various embodiments, EC 109 may be configured to perform a number of sensor 110 configurations, independently of the state of processor(s) 101, which may be in a, off, low power, sleep, or standby state.

EC 109 may also implement operations for detecting certain changes to the physical configuration or posture of IHS 100 (such as a laptop computer), and may also manage operations of other IHS devices based on the current physical configuration of IHS 100. For instance, when IHS 100 as a 2-in-1 laptop/tablet form factor, EC 109 may receive inputs from a lid position or hinge angle sensor 110, and may use those inputs to determine: whether the two sides of IHS 100 have been latched together to a closed position or a tablet position, the magnitude of a hinge or lid angle, etc. In response to these changes, the EC 109 may enable or disable certain features of IHS 100 (e.g., front or rear facing camera, etc.).

In this manner, EC 109 may identify any number of IHS physical postures, including, but not limited to: laptop, stand, tablet, or book. For example, when an integrated display 111 of IHS 100 is open with respect to a horizontal, face-up position of an integrated keyboard, EC 109 may determine IHS 100 to be in a laptop posture. When an integrated display 111 of IHS 100 is open with respect to a horizontal keyboard portion, but the keyboard is facing down (e.g., its keys are against the top surface of a table), EC 109 may determine IHS 100 to be in a kickstand posture. When the back of an integrated display 111 is closed against the back of the keyboard portion of an IHS, EC 109 may determine IHS 100 to be folded in a tablet posture. When IHS 100 has two integrated displays 111 that are open side-by-side (e.g., in a hybrid laptop with displays in both panels), EC 109 may determine an IHS 100 to be in a book posture. When an IHS 100 is determined to be in a book posture, EC 109 may also determine if the display(s) 111 of IHS 100 are arranged in a landscape or portrait orientation, relative to the user.

In some implementations, EC 109 may be installed as a Trusted Execution Environment (TEE) component to the motherboard of IHS 100. Accordingly, as a component with the root of trusted hardware of IHS 100, EC 109 may be further configured to calculate hashes or signatures that uniquely identify individual components of IHS 100. In such scenarios, EC 109 may calculate a hash value based on the configuration of a hardware and/or software component coupled to IHS 100. For instance, EC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC 109 may later recalculate a hash value based on instructions and settings loaded for use by a hardware component of IHS 100 and may compare the calculated value against the reference hash value to determine if any modifications have been made to the component, thus indicating that the component has been compromised. As such, EC 109 may validate the integrity of hardware and software components installed in IHS 100.

In some embodiments, EC 109 may provide an OOB (Out-Of-Band) or sideband channel that allows an ITDM or Original Equipment Manufacturer (OEM) to manage various settings and configurations of an IHS 100. OOB is used in contradistinction with “in-band” communication channels that operate only after networking 105 other interfaces of the IHS have been initialized, and the OS of the IHS has been successfully booted. As described in additional detail below, in some embodiments, these OOB channels supported by the EC 109 include a direct sideband management connection, such as an I2C management bus, with some of the sensors 110 of an IHS, but may rely on sensor hub interfaces for interfacing with other sensors 100 of the IHS.

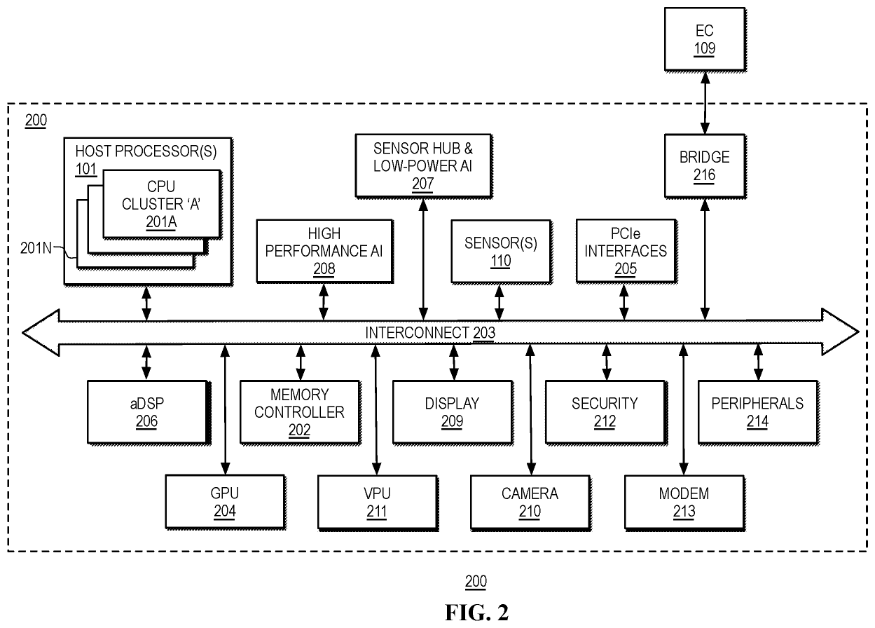

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to other IHS components, such as, for EC 109 and/or other devices within heterogeneous computing platform 200 (FIG. 2).

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), etc.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For instance, in various embodiments, host processor(s) 101 and/or other components shown in FIG. 1 (e.g., chipset 102, display controller(s) 104, communication interface(s) 105, EC 109, etc.) may be replaced by devices within heterogenous computing platform 200 (FIG. 2). As such, IHS 100 may assume different form factors including, but not limited to: servers, workstations, desktops, laptops, appliances, video game consoles, tablets, smartphones, etc.

Historically, IHSs with desktop and laptop form factors have had conventional host OSs executed on INTEL or AMD's “x86”-type processors. Other types of processors, such as ARM processors, have been used in smartphones and tablet devices, which typically run thinner, simpler, and/or mobile OSs (e.g., ANDROID, IOS, WINDOWS MOBILE, etc.). More recently, however, IHS manufacturers have started producing fully-fledged desktop and laptop IHSs equipped with ARM-based, heterogeneous computing platforms. Accordingly, host OSs (e.g., WINDOWS on ARM) have been developed to provide users with a familiar OS experience on those platforms.

FIG. 2 is a diagram illustrating an example of heterogenous computing platform 200. In various embodiments, heterogenous computing platform 200 may be implemented in one or more SoCs, FPGAs, ASICs, or the like. Heterogenous computing platform 200 may include one or more discrete and/or segregated devices or components, each having a different set of processing capabilities suitable for handling a particular type of computational task. When each device in platform 200 is tasked with executing only the types of computational tasks that it is specifically designed to execute, the overall power consumption of heterogenous computing platform 200 is minimized.

In various implementations, some of the devices in heterogenous computing platform 200 may include their own microcontroller(s) or core(s) (e.g., ARM core(s)) and corresponding firmware. In some cases, a device in platform 200 may also include its own hardware-embedded accelerator (e.g., a secondary or co-processing core coupled to a main core). Each device in heterogenous computing platform 200 may be accessible through a respective Application Programming Interface (API). Additionally, or alternatively, some devices in heterogenous computing platform 200 may execute their own OS, such as service OSs 316 described below. Each of the OSs supported by and IHS 100 and/or heterogenous computing platform 200 may utilize inputs from sensors 110 of the IHS and may thus seek to configure aspects of the operation of these sensors. However, components of the heterogenous computing platform 200, such as an SoC used to implement the heterogenous computing platform, may be designed to operate on a variety of platforms have a high-level knowledge of the particular capabilities of the sensors 110 of IHS 100, and may thus have limited ability to directly configure low-level operations by these sensors, or must rely on configuration capabilities that require updates to firmware or other instructions that require rebooting components of the IHS.

In the embodiment illustrated in FIG. 2, heterogenous computing platform 200 includes CPU clusters 201A-N that may correspond to system processor(s) 101, and that are intended to perform general-purpose computing operations. Each of CPU clusters 201A-N may include one or more processing cores and cache memories. In operation, CPU clusters 201A-N are available and accessible to the IHS's host OS 300 (e.g., WINDOWS on ARM) and other applications executed by IHS 100.

CPU clusters 201A-N may be coupled to memory controller 202 via internal interconnect fabric 203. Memory controller 202 may be responsible for managing system memory access for all of devices connected to internal interconnect fabric 203, which may include any communication bus suitable for inter-device communications within an SoC (e.g., Advanced Microcontroller Bus Architecture or “AMBA,” QuickPath Interconnect or “QPI,” HyperTransport or “HT,” etc.). All devices coupled to internal interconnect fabric 203 may communicate with each other and with a host OS executed by CPU clusters 201A-N. In some cases, devices 209-211 may be coupled to internal interconnect fabric 203 via a secondary interconnect fabric (not shown). A secondary interconnect fabric may include any bus suitable for inter-device and/or inter-bus communications within an SoC.

A GPU 204 of the heterogenous computing platform 200 produces graphical or visual content and communicates that content to a monitor or display of the IHS 100 for rendering. In some embodiments, display engine 209 may be designed to perform additional video enhancement operations. In operation, display engine 209 may implement procedures for provide the output of GPU 204 as a video signal to one or more external displays coupled to IHS 100 (e.g., display device(s) 111). PCIe interfaces 205 provide an entry point into any additional devices external to heterogenous computing platform 200 that have a respective PCIe interface (e.g., graphics cards, USB controllers, etc.).

Audio Digital Signal Processor (aDSP) 206 is a device designed to perform audio and speech operations and to perform in-line enhancements for audio input(s) and output(s). Examples of audio and speech operations include, but are not limited to: noise reduction, echo cancellation, directional audio detection, wake word detection, muting and volume controls, filters and effects, etc. In operation, input and/or output audio streams may pass through and be processed by aDSP 206, which can send the processed audio to other devices on internal interconnect fabric 203 (e.g., CPU clusters 201A-N). In some embodiments, aDSP 206 may be configured to process one or more of heterogenous computing platform 200's sensor signals (e.g., gyroscope, accelerometer, pressure, temperature, etc.), low-power vision or camera streams (e.g., for user presence detection, onlooker detection, etc.), or battery data (e.g., to calculate a charge or discharge rate, current charge level, etc.). In support of such operations, aDSP 206 may be coupled to BMU 112.

Camera device 210 includes an Image Signal Processor (ISP) configured to receive and process video frames captured by a camera coupled to heterogenous computing platform 200 (e.g., in the visible and/or infrared spectrum). Video Processing Unit (VPU) 211 is a device designed to perform hardware video encoding and decoding operations, thus accelerating the operation of camera 210 and display/graphics device 209. VPU 211 may be configured to provide optimized communications with camera device 210 for performance improvements.

Sensor hub 207 may include AI capabilities designed to consolidate information received from other devices in heterogenous computing platform 200, process context and/or telemetry data streams, and provide that information to: (i) a host OS, (ii) other applications, and/or (iii) other devices in platform 200. In collecting data, sensor hub 207 may include General-Purpose Input/Output (GPIOs) that provide Inter-Integrated Circuit (I²C), Improved I²C (I³C), Serial Peripheral Interface (SPI), Enhanced SPI (eSPI), and/or serial interfaces to receive data from sensors (e.g., sensors 110, camera 210, peripherals 214, etc.). Sensor hub 207 may include a low-power core configured to execute small neural networks and specific applications, such as contextual awareness and other enhancements.

High-performance AI device 208 is a significantly more powerful processing device than sensor hub and low-power AI device 207, and it may be designed to execute multiple complex AI algorithms and models concurrently (e.g., Natural Language Processing, speech recognition, speech-to-text transcription, video processing, gesture recognition, user engagement determinations, etc.). For example, high-performance AI device 208 may include a Neural Processing Unit (NPU), Tensor Processing Unit (TPU), Neural Network Processor (NNP), or Intelligence Processing Unit (IPU), and it may be designed specifically for AI and Machine Learning (ML), which speeds up the processing of AI/ML tasks while also freeing processor(s) 101 to perform other tasks. Using such capabilities, one or more devices of heterogeneous computing platform 200 (e.g., GPU 204, aDSP 206, sensor hub and low-power AI device 207, high-performance AI device 208, VPU 211, etc.) may be configured to execute one or more AI model(s), simulation(s), and/or inference(s).

Security device 212 may include one or more specialized security components, such as a dedicated security processor, a Trusted Platform Module (TPM), a TRUSTZONE device, a PLUTON processor, or the like. In various implementations, security device 212 may be used to perform cryptography operations (e.g., generation of key pairs, validation of digital certificates, etc.) and/or it may serve as a hardware root-of-trust (RoT) for heterogenous computing platform 200 and/or IHS 100.

Modem/wireless controller 213 may be designed to enable wired and wireless communications in any suitable frequency band (e.g., BLUETOOTH or “BT,” WiFi, CDMA, 5G, satellite, etc.), subject to AI-powered optimizations/customizations for improved speeds, reliability, and/or coverage. Peripherals 214 may include any device coupled to heterogenous computing platform 200 (e.g., sensors 110) through mechanisms other than PCIe interfaces 205.

In some cases, peripherals 214 may include interfaces to integrated devices (e.g., built-in microphones, speakers, and/or cameras), wired devices (e.g., external microphones, speakers, and/or cameras, Head-Mounted Devices/Displays or “HMDs,” printers, displays, etc.), and/or wireless devices (e.g., wireless audio headsets, etc.) coupled to IHS 100.

In some implementations, EC 215 may be integrated into heterogenous computing platform 200 of IHS 100. In other implementations EC 109 may be external to the heterogenous computing platform 200 (i.e., the EC 215 residing in its own semiconductor package) but coupled to integrated bridge 216 via an interface (e.g., enhanced SPI or “eSPI”), thus supporting the EC's ability to access the SoC's internal interconnect fabric 203, including sensor hub 207 and sensor(s) 110. Through this connectivity supported by the interconnect fabric 203, EC 109 may directly access and/or operate most or all of devices 201-216, 110 of the heterogenous computing platform 200. In particular, EC 109 may support dynamic configuration of sensors supported throughout an IHS 100 and/or heterogenous computing platform 200.

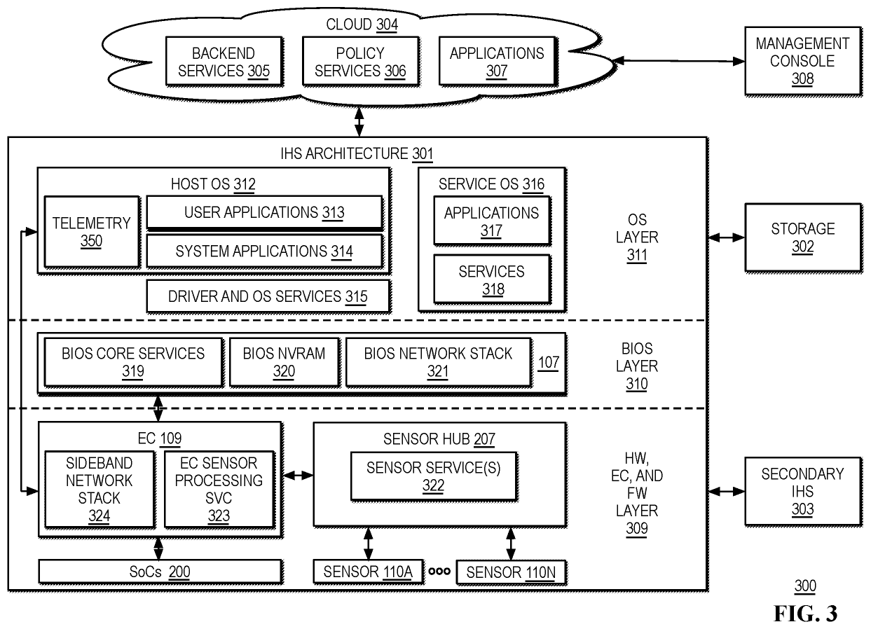

FIG. 3 is a diagram illustrating an example of architecture 300 for dynamic configuration of sensors 110A-N within a heterogenous computing platform 200. As illustrated, architecture 300 includes IHS 301 (e.g., implementing aspects of IHS 100 and/or platform 200) coupled to storage device 302 (e.g., NVMe, SSD, etc.), secondary or companion IHS 303 (e.g., a smart phone, a laptop, etc.), and cloud or remote services 304. Cloud 304 may include backend or remote services 305, policy services 306, and web applications 307. In some cases, components of cloud 304 may be accessible to IHS 301 and/or secondary IHS 303, and configurable via ITDM management console 308. IHS architecture 301 may include hardware/EC/firmware layer 309, UEFI layer 107, and OS layer 311.

OS layer 311 includes a host OS (Operating System) 312 that is executed by host processor(s) 101. A variety of software applications may operate within the OS 312, where these applications may include user applications 313 and system applications 314, one or more telemetry applications 350. OS layer 311 may also include various drivers and other core OS operations, such as the operation of a kernel. As described, various components of a heterogenous computing platform 200 may independently run their own operating systems, such as an OS run by an SoC. Within IHS architecture 301, some of these discrete operating systems operating on individual components of the heterogenous computing platform 200 may be considered service OSs 316, where each service OS may each include its own applications 317 and services 318. As described in additional detail below, each of these applications 313, 314, 350 that operate within the host OS 312 and applications 317, 318 that operate within a service OS 316 may utilize inputs from sensors 110 that may be located throughout the IHS 301 and/or heterogenous computing platform 200.

For example, telemetry applications 350 may collect data generated by a variety of different sensors 110, where some of the collected telemetry data may be logged or stored for offline use (e.g., training machine learning algorithms) and some of the collected telemetry data may be used directly, such as in initiating heighted security protocols in response to threats detected based on the collected telemetry data. In another illustrative example, system application 314 of the OS 312 may include applications that initiate power saving procedures in response to user presence determinations that are based on data collected by one or more sensors 110, such as system applications 314 that may dim displays and initiate other power saving operations in response to detecting a lack of user presence in proximity to the IHS 100. In another illustrative example, user applications 313 of the OS 312 or service OS 316 may include gaming applications that reconfigure the user gaming inputs that are available based on sensor inputs that indicate a specific physical posture (e.g., tent mode, landscape mode, etc.) of the IHS.

BIOS layer 310 may include BOS core services 319, BIOS NVRAM 320, and BIOS network stack 321. BIOS core services 319 may include operations for identifying and validating the detected hardware components of an IHS. The BIOS network stack 321 may be utilized during initialization of the IHS in support of validation procedures, such as in retrieving reference signatures corresponding to authentic firmware instructions for hardware components of an IHS 100. BIOS core service 319 may also support operations for configuring certain hardware of an IHS, in particular operations for configuring sensors 110A-N of the IHS. In many existing systems, configuration of sensor capabilities via BIOS requires updates to BIOS firmware, thus requiring restarting the BIOS and as result, rebooting the IHS 100. As described in additional detail below, embodiments support dynamic configuration of capabilities of sensors 110A-N by EC 109 without reliance on BIOS 107 capabilities and thus without requiring updates to firmware and without requiring any restarting of the IHS 100, or restarting or reinitialization of any of the hardware or software of the IHS 100, thus supporting immediate reconfiguration of sensor capabilities.

As illustrated, IHS architecture 301 also includes a hardware/EC/firmware layer 309 that includes EC 109 and sensor hub 207. As described above, EC 109 may implement a variety of procedures for management of individual hardware of an IHS 100 and of the IHS itself, including management of the various power states that are supported by the IHS. EC 109 is configured to execute one or more sensor services 323 that interface with sensor hub 207 in implementing various features of an IHS 100, such response to user-presence determination by the sensor hub 207 that is acted upon by the EC 109 in initiation heightened security protocols. As described, EC 109 may interface with some or all of the individual hardware components/systems of an IHS via sideband management channels that are separate from inline communication channels used by the host processor 101 and SoCs 200.

As described above, sensor hub 207 may receive inputs from some or all of the sensors 110A-N of an IHS 100. Sensor hub 207 may implement a variety of sensor service(s) 322 for communicating with and collecting data from sensors 110A-N. In some embodiments, sensor hub 207 may implement shock detection procedures that may incorporate inputs from inertial and other sensors 110A-N of an IHS. Such shock detection procedures may detect shocks experienced by an IHS 110 and may characterize and assess detected shocks in evaluating possible damage to the IHS. In response to various conditions, such as determining the IHS is being transported, shock detection procedures may prefer to adjust certain sensor settings in order to direct available resources at detecting specific types and/or magnitudes of shock events, and to refrain from expending power in detecting all other shock events. Delays in modifying these sensor capabilities precludes such shock detection procedures and other applications that relying on sensor inputs from adapting the sensor's capabilities in response to changes in the context of the user's operation of an IHS 100.

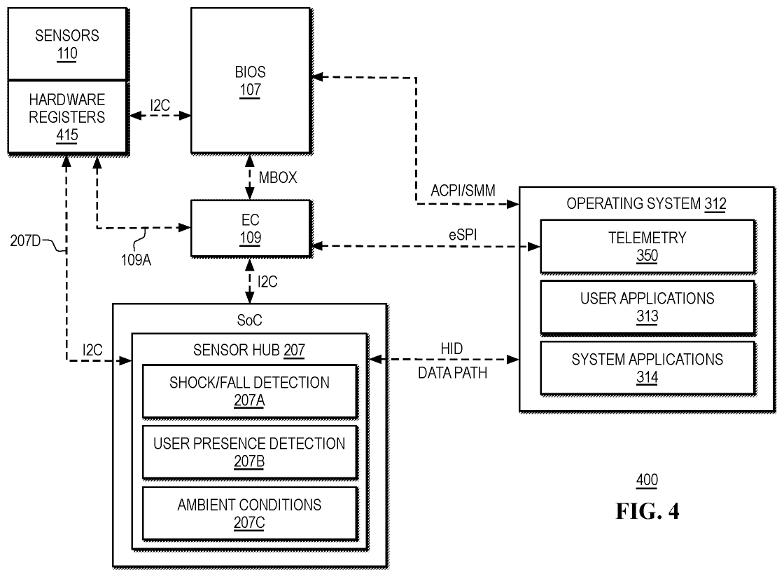

FIG. 4 is a diagram illustrating certain components of an IHS configured, according to some embodiments, for dynamic configuration of sensors of the IHS. As described above, IHSs may include capabilities 207a-c that implemented by a sensor hub 207 of the IHS 100 and that may utilize a wide variety of inputs from sensors 110 of the IHS. Sensor hub 207 may implement various operations that incorporate information from one or more sensors 110 of an IHS. For instances, user presence detection 207b operations by sensor hub 207 may locate, and in some instances identify, individuals in close proximity to an IHS, such as based on camera inputs and time-of-flight type sensor 110 inputs. Sensor hub 207 may additionally or alternatively implement ambient condition operations 207c that monitor and report environmental conditions detected by sensors 110, such as ambient lighting and ambient temperature information. Shock detection capabilities 207a may incorporate information from accelerometer and gyroscope sensors to detect falls or other shocks experienced by an IHS 100.

In some instances, one or more applications 313, 314, 350 of the host OS 312 may also utilize sensor inputs. For instance, host OS 312 system applications 314 may implement procedures for initiating heighted security protocols upon detecting the IHS 100 is being operated in a public location, as determined based on one or more sensor 110 inputs providing indications of the current location of the IHS. Host OS 312 may also include user applications 313 such as video games that adjust certain video game settings based on sensor 100 inputs, such as adjusting volume settings in response to detecting an individual other than the user approaching the IHS. Host OS 312 may also include telemetry 350 applications that collect a wide variety of sensor 110 data.

In existing systems, configuration of low-level sensor capabilities by sensor hub 207 and host OS 312 requires modifications to BIOS 107. In some instances, updates to sensor settings may require updates to BIOS 107 firmware, thus requiring the BIOS and consequently the IHS 100 to be restarted. As illustrated in FIG. 4, sensor hub 207 may be directly coupled to some of the sensors 110 supported by an IHS 100, such as via a direct I2C coupling 207d. Such configurations provide the sensor hub 207 with direct access to certain sensors, thus facilitating certain sensor hub operations during low power intervals, such as operations of shock detection procedures 207a while IHS 100 is in a modern standby power state. However, in scenarios where sensor hub 207 is implemented by an SoC 200 that is not designed for a specific IHS 100 architecture, the SoC has a limited knowledge of low-level sensor capabilities and instead relies on high-level interfaces for interoperation with sensors 110. In particular, an SoC 200 relies on BIOS 107, in some instances via configurations supported by host OS 312, to configure low-level capabilities of sensors 110, while utilizing high level APIs supported by sensors 110 to directly configure high-level capabilities of the sensors, such as reporting frequency and reporting thresholds.

In embodiments, request to modify low-level sensor 110 operations are instead directed to EC 109. Through embodiments, requests to modify low-level sensor capabilities may be submitted by host OS 312 applications 313, 314, 350 to a sensor API maintained by EC 109, such as in order to adjust ambient light detection sensitivity settings in response to determining the user has relocated operation of the IHS from an outdoor location to a known indoor location. Using the same API of EC 109, sensor hub 207 may also issue request to modify settings of sensors 110, such as to adjust accelerometer sensitivity settings in response to detecting the user moving from the known indoor location to an outdoor location. In such scenarios, restarts to the BIOS and/or IHS, or reinitialization of an software, in order to implement these sensor adjustments frustrates the ability to perform the adjustments in a timely manner.

Upon receipt of a request to modify a sensor setting, EC 109 determines how to interface with a particular sensor. As described in additional detail below, EC 109 may include capabilities for communicating directly with certain sensors, such as battery condition sensors, directly via sideband management signaling pathways 109a. However, EC 109 may be required to interface with some sensors, such as a gyroscope or accelerometer, via interfaces 207d provided by sensor hub 207. Accordingly, EC 109 determines whether the sensor for which a configuration request has been received is accessible directly 109a or via a sensor hub 207.

In either scenario, EC 109 identifies one or more hardware register 415 settings to be made in order to reconfigure a sensor 110 as requested. In embodiments, sensors 110 that may be dynamically configured may be those that are configurable through hardware register settings. For instance, modifications to a designated hardware register 415 of an accelerometer may be used to configure the range of forces that are to be detected by the accelerometer. In this same manner, hardware register 415 settings of an ambient light sensor may be used to configure a transition curve used to detect transitions from one ambient light environment to another. Accordingly, EC 109 may be configured to translate supported configuration for a particular sensor to one or more modifications to the hardware registers of the sensor.

Whether initiated directly, via 109a, or initiated via an interface 207a supported by a sensor hub 207 that controls access to a particular sensor, the EC 109 modifies the hardware registers 415 of the identified sensors. Through such modifications, EC 109 embodiments provide immediate configurability of certain sensor 110 capabilities, thus enabling applications operated by host OS 312 and/or SoC 200 to modify these sensor capabilities in a timely manner.

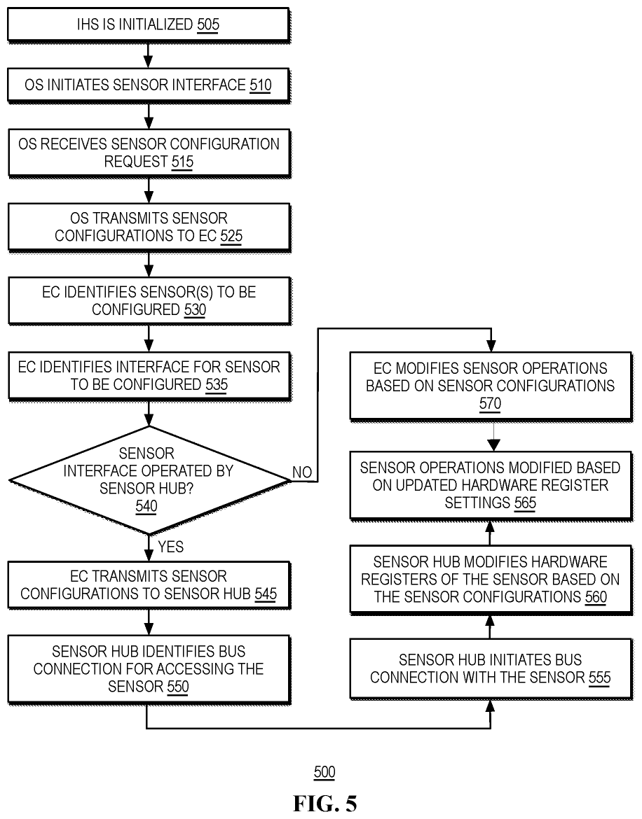

In that regard, FIG. 5 is a diagram illustrating an example of method 500 for dynamic configuration of sensors 110 within a heterogenous computing platform 200. As described above, conventional configuration of sensors by OS applications requires modifications to the BIOS 107 firmware, thus requiring re-starting of the BIOS, and thus of the IHS 100. Embodiments may thus begin, at 505, with the initialization of an IHS 100 that includes a heterogenous computing platform 200. Upon initialization, the IHS 100 may powered and validated as operating using trusted hardware and using authentic instructions. Initialization may include booting of one or more operating systems. In some embodiments, the host processor 101 may operate a host OS 312, where this host OS 312 may be operated by a user of the IHS 100 through various user inputs. In some embodiments, multiple other operating systems, such as one or more service OSs 316, may be operated by other processors or by SoCs of the heterogenous computing platform 200.

Once the host OS 312 has been booted, at 510, the host OS initiates an interface for accessing and configuring sensors 110 of the IHS 100. In some embodiments, any of the service OSs 316 that are booted by the IHS may similarly initiate a sensor interface. In some embodiments, each OS 312, 316 may initiate a distinct sensor interface that provides capabilities for accessing a particular set of sensors 110. In some embodiments, each OS 312, 316 may initiate an identical sensor interface that provides capabilities for accessing and/or configuring all of the sensors 110 that are available by the IHS 100. In some embodiments, the sensor interface initiated by the host OS 312 may support both accessing and configuring sensors 110, while any sensor interfaces initiated by a service OS 316 may only support accessing sensors 110 in order to collect data from the sensors, without any capabilities for these service OS interfaces to configure the collection capabilities of the sensors.

As described above, a variety of user and system applications that operate on an IHS 100 may receive and process data collected by sensors 110 of the IHS. Each of the applications of the OSs 312, 316 may request modifications to the operation of one or more sensors 110 and, at 515, may issue such a request to the sensor interface initiated by the respective OS in which an application 313, 314, 350 operates. In some scenarios, collected sensor 110 data may be used in providing user presence detection, where the status of a user's presence in proximity to the IHS may trigger a variety power saving, privacy and/or security operations by these operating system software applications. For instance, a failure to detect a validated user in close proximity to the IHS 100 based on readings by sensors 110 may result in system applications of the host OS 312 initiating privacy procedures that blur the output of displays of the IHS in order to protect displayed data from passersby. Also as described, one or more telemetry systems 350 may operate within the host OS 312, where these telemetry systems may collect and evaluate data collected by sensors 110.

Each of these telemetry systems 350, user applications 313, and system applications 314 of the host OS 312 may thus collect and evaluate data collected by sensors 110. However, these applications may improve their capabilities through adjustments to the data that is being collected and reported by one or more of the individual sensors 110. For instance, a telemetry system 350 may increase data collection and/or fidelity settings by one or more sensors 110 in response to detecting a threat condition or other security concern. In some embodiments, data collected by telemetry systems 350 may be used in training of machine learning algorithms, such as in collecting data used to establish threat patterns that are indicative of malicious activity. As indications of potential malicious activity are identified by the machine learning algorithms, more targeted and/or more precise training data may require adjustments to the sensors 110 used to collect the telemetry that is being used in training. In existing systems, for applications running in a host OS 312 or service OS 316 to modify the data collection and reporting by sensors 110 requires updates to the BIOS firmware, which requires re-booting the BIOS and thus of the IHS.

In embodiments, sensor configurations by the host OS 312, and/or by any service OSs 316, are directed, at 525, to EC 109 via a sensor interface maintained by the EC. Through the sensor interface of the EC 109, the OSs 312, 316 may transmit the set of sensor configurations. In embodiments, the sensor interface of the EC 109 provides a platform-agnostic set of sensor configurations. In different heterogenous computing platform 200, different processors, SoCs and other computing clusters may be present, thus presenting a variety of possible sensor interfaces. As a result, OSs 312, 316 may be unable to account for all of the possible sensors that may be available in a heterogenous computing platform 200. Accordingly, in embodiments, the EC 109 maintains a platform-agnostic API for configuring each of the different types of sensors that may be available within the heterogenous computing platform 200.

In some embodiments, the platform-agnostic sensor API maintained by the EC 109 may provide configuration of specific sensor capabilities, such as in configuring sensitivity settings used by an accelerometer sensor 110. In some embodiments, the platform-agnostic sensor API maintained by the EC 109 may provide configuration of capabilities that utilize multiple sensors 110 as inputs, such as in configuring user presence detection settings that rely on infrared and camera sensors for use in detecting the presence of an individual in close proximity to an IHS 100. Using the sensor API of the EC 109, such configurations may be transmitted by the OSs 312, 316.

In response to such requests, at 530, the EC 109 identifies the one or more sensors 110 that are to be configured. In some instances, the provided configurations are directly usable in modifying capabilities of a sensor 110. For instance, settings of an ambient light sensor may be configured based on the provided configurations, such as configurations that request increased sensitivity of ambient light sensor measurements, where such configurations may be generated by a system application 314 of the host OS 312 in response to detecting the user has moved from a well-lit location to a dimly lit location. In such instances, the ambient light sensor is identified as the target for the provided configurations.

In some instances, multiple sensors 110 may be identified for configuration by the EC 109 based on the received sensor configurations. For example, in a scenario where an application requests modifications to user presence detection capabilities of an IHS, the EC 109 may identify both an infrared line-of-sight sensor and one or more camera sensors (e.g., front-facing camera, rear-facing camera) that are used in generating user presence detection determinations. Once the sensor(s) to be configured have been identified, at 535, the EC 109 identifies the appropriate interface for configuring each of the sensors.

Within a heterogenous computing platform 200, some or all of the sensors 110 that are available are accessed, in some instances exclusively, through a sensor hub 207. In some scenarios, some of the sensors 110 of an IHS may be accessed by the EC 109, such as through sideband management signaling pathways of the EC. Accordingly, based on the sensor(s) to be configured, the EC 109 determines the sensor interface for accessing each of these sensors. At 540, the EC 109 determines whether a sensor to be configured is accessible directly by the EC 109. For instance, EC 109 may manage certain IHS 100 sensors, such as thermal, mechanical and physical security sensors, directly through an I2C management bus that connects the EC to one or more sensors.

As indicated in FIG. 5, at 570, the EC 109 modifies operations of one or more of these directly connected sensors through management operations supported by this I2C sideband management pathway. In particular, the EC 109 may master an I2C bus in transmitting a configuration update to an individual sensor. For example, in response to detecting rough handling of the IHS, a configuration request to the EC 109 is used to enable torsion measurements by hinge angle sensors of a laptop or hybrid laptop IHS, thus detection twisting of the panels of the IHS relative to each other. Such torsion detection capabilities of the hinge angle sensors are not required under normal operating conditions, while the standard hinge angle movement and measurement capability itself must remain enabled at all times in order to trigger system state transitions. Accordingly, in embodiments, configurations provided to the EC 109 enable context dependent enablement of such sensor-based capabilities without requiring a restart of the IHS, thus supporting conservation of power that is used to operate these sensors, while still utilizing all of the capabilities of a sensor based on the current operating context.

In many scenarios, many of the sensors 110 of IHS 100 may be accessed via a sensor hub 207 that is adapted for evaluation of collected sensor data, such as in synthesizing inputs from multiple sensors in making user presence determinations, or in making determinations regarding the physical posture in which a hybrid laptop IHS is configured. In scenarios where the sensor(s) being configured are accessed by the sensor hub 207, at 545, the EC 109 transmits the sensor configurations to the sensor hub 207. In different heterogenous computing platforms 200, different sensor hubs may be utilized. As described above, a sensor hub 207 may be a function supported by an SoC such that different SoCs may support different sensor-based capabilities. Accordingly, the EC 109 may account for the different sensor hubs that may be implemented by different heterogenous computing platforms 200. Through embodiments, the sensor interface maintained by EC 109 allows the different sensor hubs to be utilized without the sensor hubs having detailed knowledge of the low level configurable capabilities of the available sensors 110.

Despite the differences in the different sensor hubs 207 that may be utilized in different heterogenous computing platforms 200, the underlying sensors 110 may remain the same, or nearly the same. For instance, an ambient light sensor of an IHS 100 may be utilized in a variety of different manners by different sensor hubs, but the configurable capabilities of this ambient light sensor remain the same regardless of the different uses of the data collected by the ambient light sensor by the different sensor hubs. As described, in some scenarios, the sensor configurations provided by the EC 109 are usable directly in configuring sensor 110, without reliance on any sensor configuration abilities of the sensor hub 207 through which the sensor is accessed. In such instances, hardware register settings are modified directly by EC 109. In scenarios where the sensor interface is maintained by a sensor hub, the EC 109 transmits sensor configurations to the sensor hub 207, where the included configurations provide specific modifications to one or more hardware registers of a specific sensor.

Upon receiving a sensor configuration from the EC 109, at 550, the sensor hub 207 identifies the specific sensor to be configured and the bus connection by which this sensor is accessed by the sensor hub. Similar to the management connections used by the EC 109 with regard to sensors directly managed by the EC, the sensor hub 207 may interface with sensor 110 through I2C connections that link the sensor hub to one or more distinct sensors. Once the bus interface for communicating with the sensor to be configured has been identified, at 555, the sensor hub 207 masters the bus to take exclusive control of the bus for transmission of the configurations to the sensor.

Via the established bus connection, at 560, the sensor hub 207 transmits the configurations to the appropriate sensor 110 and applies the configurations. In particular, the configurations provided by the EC 109 specify one or more changes to the hardware register settings supported by the sensor being configured. Accordingly, in some embodiments, the transmission of configurations by the sensor hub 207 may invoke a GPIO signal of the sensor in order to notify the sensor of an update to a hardware register supported by that sensor. In some embodiments, the configurations provided to the sensor hub 207 by the EC 109 are commands for writing values to specific hardware register addresses of a particular sensor. In such embodiments, the sensor hub 207 may serve as a conduit for these commands issued by the EC 109 and may thus relays these commands to the appropriate sensor without further processing of the command.

In some embodiments, as part of factory provisioning of IHS 100, EC 109 may be provided with a listing of hardware register addresses used by sensors 110 that are installed in an IHS, where this listing can then be used by the EC 109 in generating commands that can be forwarded by the sensor hub to the appropriate sensor, without the sensor hub having knowledge of the hardware registry settings that are supported by each of the sensors 110 of the IHS 100. In some embodiments, queries to cloud 304 resources by the EC 109 may be used during initialization of the IHS 100 in order to generate a catalog of addresses for each hardware register supported by each sensor 110 of the IHS.

Once the hardware registers for a sensor have been modified based on instructions generated by the EC 109 and forwarded by the sensor hub 207, at 565, the operations of the sensor are immediately modified. For instance, in a scenario where OS 312, 316 applications request a modification to the user presence detection capabilities of an IHS in response to detecting an increased threat profile, such as detecting multiple individuals in close proximity to the IHS, the EC 109 may receive such a request and identify the sensors settings that correspond to the requested modification, such as increasing the sensitivity settings of an infrared time-of-flight sensor that is used to detect individuals in close proximity to the IHS.

In another illustrative example, detected rough handling of an IHS may trigger OS 312, 316 applications to request modifications to the settings used by an accelerometer of the IHS, such as to expand the observation window setting of the accelerometer in order to increase the range of forces that are detectable by the accelerometer. During normal operations, the accelerometer may be configured to detect extreme movements, such as falls and drops, and may thus refrain from detecting minor movements that regularly occur when a user is operating a mobile IHS, such as a laptop or tablet. However, an OS 312, 316 may include applications that configure an IHS for operating is a specific physical environment as soon as the IHS is detected as being moved within that environment, such as to load an email client when detecting the IHS is in proximity of a known docking station. Accordingly, upon detecting indications that the IHS could be in transit, these OS 312, 316 applications may request an increase in accelerometer data collection and an expansion of the range of forces that are being detected in order to confirm whether the IHS is indeed being transported, such as based on detecting minor movements that are indicative of the IHS being carried while a user is walking. Accordingly, in some embodiments, the EC 109 receives the request to modify operation of the accelerometer and identifies the registry setting modifications that will implement the requested reconfiguration of the sensor. Once these hardware registers have been updated, the sensor immediately begins use of these settings.

Through embodiments, modifications to hardware registers of sensors by EC 109, whether directly or via a sensor hub 207, allow immediate modification of the operation of sensors 110. In existing systems, modifications to such hardware-level settings supported by sensors require modifications to the BIOS firmware, thus requiring restarting of the IHS. As a result, sensors in existing systems are configured to detect all possible scenarios, such as by configuring an accelerator with a broad observation window that detects extreme movements as well as regular movements at all times. This results in wasted power and other resources of the IHS. Through embodiments, the operation of sensors 110 may be immediately modified, thus allowing OS 312, 316 applications to adapt sensor operations in response to changes in the context in which an IHS 100 is being operated.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a plurality of sensors;
an Embedded Controller (EC); and
a memory coupled to, or integrated into, the EC, wherein the memory comprises program instructions that, upon execution by the EC, cause the EC to:
receive a sensor configuration request;
identify a first of the plurality of sensors of the IHS for configuration based on the request;
identify an interface for accessing the first sensor;
identify a plurality of hardware registers for configuring the first sensor; and
via the identified interface, modify the plurality of hardware registers of the first sensor based on the sensor configuration request.

2. The IHS of claim 1, wherein the sensor comprises at least one of: an accelerometer, a gyroscope, or an Inertial Measurement Unit (IMU).

3. The IHS of claim 2, wherein the sensor configuration request comprises a request to modify a sensitivity setting for use by an accelerometer in detecting shock events experienced by the IHS.

4. The IHS of claim 1, wherein the sensor configuration request is received from an operating system application running on the IHS.

5. The IHS of claim 1, wherein the interface for accessing the first sensor comprises a sideband management pathway between the first sensor and the EC.

6. The IHS of claim 1, wherein the interface for accessing the first sensor comprises an interface operated by a sensor hub of the IHS.

7. The IHS of claim 6, wherein the sensor hub is implemented by an SoC (System-on-Chip) of the IHS.

8. The IHS of claim 7, wherein the SoC receives the modifications transmitted by the EC and relays the modifications to the first sensor without interfacing with the plurality of hardware registers of the first sensor.

9. The IHS of claim 8, wherein the modifications are requested by a service OS operating on the SoC.

10. The IHS of claim 1, wherein operations of the first sensor are updated according to the configuration request without reinitializing hardware or software of the IHS.

11. The IHS of claim 1, wherein operations of the first sensor are updated according to the configuration request without modifications to firmware used to operate the IHS.

12. A method for configuring sensors of an Information Handling System (IHS) by an Embedded Controller (EC) of the IHS, the method comprising:
receiving, by the EC, a sensor configuration request;
identifying, by the EC, a first of the sensors of the IHS for configuration based on the request;
identifying, by the EC, an interface for accessing the first sensor;
identifying, by the EC, a plurality of hardware registers for configuring the first sensor; and
via the identified interface, modifying, by the EC, the plurality of hardware registers of the first sensor based on the sensor configuration request.

13. The method of claim 12, wherein the sensor configuration request is received from an operating system application running on the IHS.

14. The method of claim 12, wherein the interface for accessing the first sensor comprises a sideband management pathway between the first sensor and the EC.

15. The method of claim 12, wherein the interface for accessing the first sensor comprises an interface operated by a sensor hub of the IHS.

16. The method of claim 15, wherein the sensor hub is implemented by an SoC (System-on-Chip) of the IHS.

17. The method of claim 16, wherein the SoC receives the modifications transmitted by the EC and relays the modifications to the first sensor without interfacing with the plurality of hardware registers of the first sensor.

18. A computer-readable storage device having instructions stored thereon, wherein execution of the instructions by an Embedded Controller (EC) of an IHS (Information Handling System) causes EC to:
receive a sensor configuration request;
identify a first of the plurality of sensors of the IHS for configuration based on the request;
identify an interface for accessing the first sensor;
identify a plurality of hardware registers for configuring the first sensor; and
via the identified interface, modify the plurality of hardware registers of the first sensor based on the sensor configuration request.

19. The storage device of claim 18, wherein the interface for accessing the first sensor comprises a sideband management pathway between the first sensor and the EC.

20. The storage device of claim 18, wherein the interface for accessing the first sensor comprises an interface operated by a sensor hub of the IHS.
